(19) United States
(12) Patent Application Publication
(10) Pub. No.: US 2015/0334443 A1
(43) Pub. Date: Nov. 19, 2015

(54) METHOD AND APPARATUS FOR SPEECH RECOGNITION USING SMART REMOTE CONTROL

(71) Applicant: Electronics and Telecommunications Research Institute, Daejeon (KR)

(72) Inventors: Jeon Gue PARK, Daejeon (KR); Eui Sok CHUNG, Daejeon (KR)

(73) Assignee: Electronics and Telecommunications Research Institute, Daejeon (KR)

(21) Appl. No.: 14/612,394

(22) Filed: Feb. 3, 2015

(30) Foreign Application Priority Data
May 13, 2014 (KR) 10-2014-0057307

(51) Int. Cl. H04N 21/422; G10L 15/22; H04N 21/482

(52) U.S. Cl. CPC H04N 21/42203; H04N 21/42204; H04N 21/4828; G10L 15/22; G10L 2015/223

(57) ABSTRACT

A speech recognition broadcasting apparatus that uses a smart remote control and a controlling method thereof, the method including receiving a runtime resource for speech recognition from a speech recognition server; receiving a speech signal from the smart remote control; recognizing the speech signal based on the received runtime resource for speech recognition; transmitting a result of recognition of the speech signal to the smart remote control; receiving at least one of EPG (Electronic Program Guide) search information or control information of the speech recognition broadcasting apparatus that are based on the result of recognition from the smart remote control; and outputting a search screen or controlling the speech recognition broadcasting apparatus based on the EPG search information or control information of the speech recognition broadcasting apparatus.

### CROSS-REFERENCE TO RELATED APPLICATION

The present application claims priority to Korean patent application number 10-2014-0057307, filed on May 13, 2014, the entire disclosure of which is incorporated herein in its entirety by reference.

### BACKGROUND

1. Field of Invention

Various embodiments of the present invention relate to a method and apparatus for speech recognition using a smart remote control.

2. Description of Related Art

With the recent advancement of numerous electronic apparatuses, and various functions being integrated into one apparatus, various kinds of user interfaces for controlling those electronic apparatuses, for example a remote control, mouse, and touch input and so forth have been developed and used.

And recently, user interfaces are being developed that recognize a user's speech and use the user's speech, but using a user's speech increases the amount of data to be processed, thereby reducing the processing speed and convenience, which is a problem.

### SUMMARY

Various embodiments of the present invention are directed to a method and apparatus for speech recognition using a smart remote control.

One embodiment of the present invention provides a method for controlling a speech recognition broadcasting apparatus that uses a smart remote control, the method including: receiving a runtime resource for speech recognition from a speech recognition server; receiving a speech signal from the smart remote control; recognizing the speech signal based on the received runtime resource for speech recognition; transmitting a result of recognition of the speech signal to the smart remote control; receiving at least one of EPG (Electronic Program Guide) search information or control information of the speech recognition broadcasting apparatus that are based on the result of recognition from the smart remote control; and outputting a search screen or controlling the speech recognition broadcasting apparatus based on the EPG search information or control information of the speech recognition broadcasting apparatus.

Another embodiment of the present invention provides a method for controlling a speech recognition broadcasting apparatus that uses a smart remote control, the method including: transmitting a speech signal to a speech recognition server; receiving a result of recognition of the speech signal recognized based on a runtime resource for speech recognition from the speech recognition server; and transmitting at least one of EPG search information and control information of the speech recognition broadcasting apparatus that are based on the result of recognition to the speech recognition broadcasting apparatus.

Another embodiment of the present invention provides a speech recognition broadcasting apparatus that uses a smart remote control, the apparatus including: a communication unit that communicates with an external apparatus; and a controller that receives a runtime resource for speech recognition from a speech recognition server through the communication unit, receives a speech signal from the smart remote control, recognizes the speech signal based on the received runtime resource for speech recognition, transmits a result of recognition of the speech signal to the smart remote control through the communication unit, receives at least one of EPG search information and control information of the speech recognition broadcasting apparatus that are based on the result of recognition from the smart remote control, and outputs a search screen or controls the speech recognition broadcasting apparatus based on the EPG search information or control information of the speech recognition broadcasting apparatus.

Another embodiment of the present invention provides a smart remote control including a communication unit that communicates with an external apparatus; and a controller that controls to transmit a speech signal to a speech recognition server through the communication unit, receive a result of recognition of the speech signal recognized based on a runtime resource for speech recognition from the speech recognition server, and transmit at least one of EPG search information and control information of the speech recognition broadcasting apparatus that are based on the result of recognition to the speech recognition broadcasting apparatus.

According to embodiments of the present invention, it is possible to provide a method and apparatus for speech recognition using a smart remote control.

### BRIEF DESCRIPTION OF THE DRAWINGS

The above and other features and advantages of the present invention will become more apparent to those of ordinary skill in the art by describing in detail exemplary embodiments with reference to the attached drawings in which:

FIG. 1 is a view illustrating a speech recognition broadcasting system that uses a smart remote control.

FIG. 2 is a flowchart illustrating a method for operating a speech recognition broadcasting system that uses a smart remote control according to an embodiment of the present invention;

FIG. 3 is a flowchart illustrating a method for controlling a speech recognition broadcasting apparatus that uses a smart remote control according to an embodiment of the present invention;

FIG. 4 is a flowchart illustrating a method for operating a speech recognition broadcasting system that uses a smart remote control according to another embodiment of the present invention;

FIG. 5 is a flowchart illustrating a method for controlling a speech recognition broadcasting apparatus that uses a smart remote control according to another embodiment of the present invention;

FIG. 6 is a view illustrating an inner structure of a speech recognition broadcasting apparatus according to another embodiment of the present invention; and

FIG. 7 is a view illustrating an inner structure of a smart remote control apparatus according to another embodiment of the present invention.

### DETAILED DESCRIPTION

The present invention will be described more fully hereinafter with reference to the accompanying drawings, in which embodiments of the invention are shown. This invention may, however, be embodied in different forms and should not be construed as limited to the embodiments set forth herein.

Furthermore, ‘connected’ represents that one component is directly connected to another component or indirectly connected through another component. In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

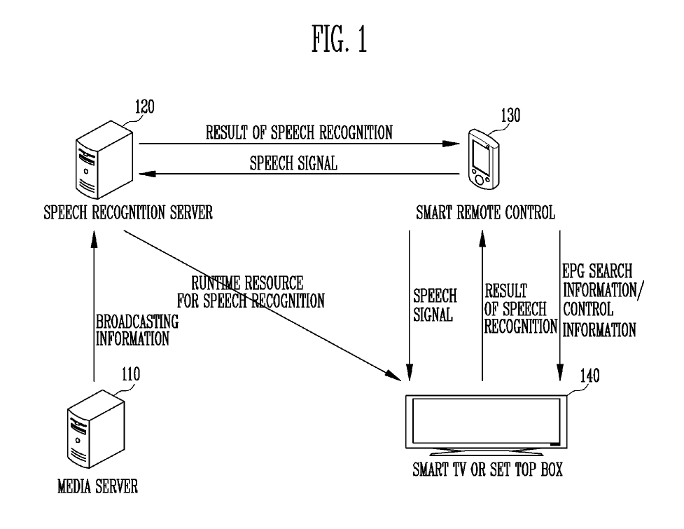

FIG. 1 is a view illustrating a speech recognition broadcasting system that uses a smart remote control.

Referring to FIG. 1, a speech recognition broadcasting system that uses a smart remote control according to an embodiment of the present invention may include a media server 110, speech recognition server 120, smart remote control 130, and speech recognition broadcasting apparatus 140.

The media server 110 is a server that includes broadcasting information, and the media server 110 may transmit the broadcasting information to the speech recognition server 120 upon request by the speech recognition server 120. Herein, the broadcasting information may include EPG (Electronic Program Guide) information. Furthermore, the media server 110 may transmit contents to speech is recognition broadcasting apparatuses 140 such as a smart TV and Set Top Box and so forth.

The speech recognition server 120 is a server that processes speech. The speech recognition server 120 receives a speech signal from an external apparatus, for example the smart remote control 130 and so forth, analyzes and processes the received speech signal, and transmits a result thereof. The speech recognition server 120 may directly analyze or process a speech signal as aforementioned, but in a case where an external apparatus directly processes a speech signal, the speech recognition server 120 may assist the external apparatus. That is, the speech recognition server 120 may transmit a runtime resource to speech recognition broadcasting apparatuses 140 such as a smart TV, Set Top Box and so forth, and assist the speech recognition broadcasting apparatuses 140 to process a speech signal.

The smart remote control 130 may control a speech recognition broadcasting apparatus 140 such as a smart TV and Set Top Box and so forth. The smart remote control 130 may transmit a speech signal to the speech recognition broadcasting apparatus 140 and receive a result thereof, and transmit EPG search information or control information to the speech recognition broadcasting apparatus 140 according to the result. Furthermore, the smart remote control 130 may directly transmit a speech signal to the speech recognition server 120 and receive a result thereof, and transmit EPG search information or control information to the speech recognition broadcasting apparatus 140 according to the result.

The speech recognition broadcasting apparatus 140 receives contents and displays the received contents. The speech recognition broadcasting apparatus 140 may include a smart TV and Set Top Box and so forth. In a case where the speech recognition broadcasting apparatus 140 is a Set Top Box, it may be connected to a separate display apparatus and display the contents. Furthermore, the speech recognition broadcasting apparatus 140 may receive a speech signal from the smart remote control 130, process and analyze the speech signal, transmit a result thereof to the smart remote control 130, and receive EPG search information or control information. Herein, the speech recognition broadcasting apparatus 140 may receive a runtime resource for speech recognition from the speech recognition server 120, and process the speech signal.

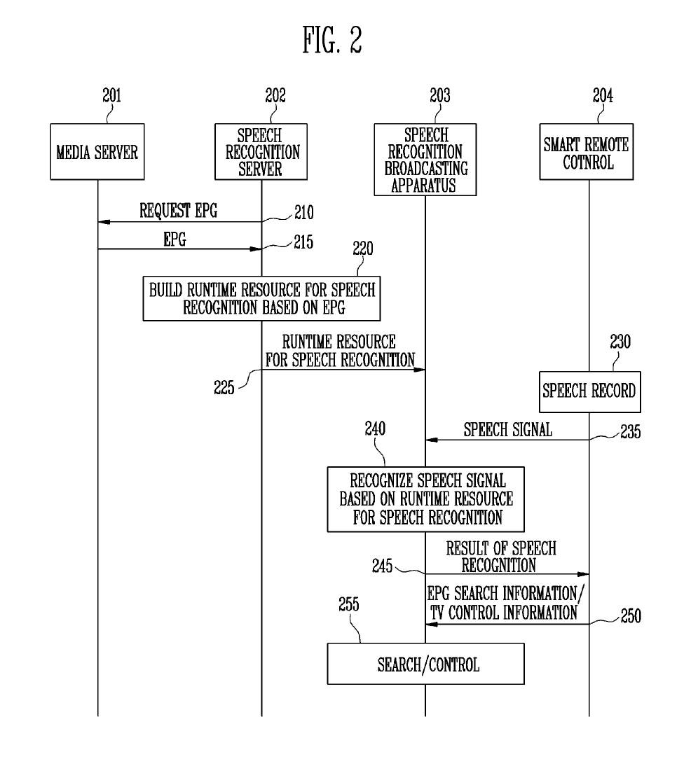

FIG. 2 is a flowchart illustrating a method for operating a speech recognition broadcasting system that uses a smart remote control according to an embodiment of the present invention.

Referring to FIG. 2, first of all, at step 210, a speech recognition server 202 requests for EPG information to a media server 201, in which case the media server 201 receives the request, and then at step 215, the media server 201 transmits the EPG information to the speech recognition server 202.

Then, at step 220, the speech recognition server 202 creates a runtime resource for speech recognition based on the received EPG information. Herein, at step 215, the speech recognition server 202 may create a runtime resource for speech recognition based on the EPG information received from the media server 201. At step 225, the speech recognition server 202 transmits the created runtime resource for speech recognition to a speech recognition broadcasting apparatus 203. According to the embodiment illustrated in FIG. 2, the speech recognition broadcasting apparatus 203 receives the runtime resource for speech recognition from the speech recognition server 202 to directly analyze and process a speech signal.

At step 230, a smart remote control receives a user's speech and converts the user's speech into a speech signal, and at step 235, the smart remote control transmits the speech signal to the speech recognition broadcasting apparatus 203. The speech recognition broadcasting apparatus 203 that received the speech signal proceeds to step 240, wherein it recognizes the speech signal based on the runtime resource for speech recognition received at step 225.

Then, at step 245, the speech recognition broadcasting apparatus 203 transmits a result of speech recognition to a smart remote control 204, and the smart remote control 204 receives the result, and then at step 250, the smart remote control 204 transmits at least one of EPG search information and control information of the speech recognition broadcasting apparatus that are based on the result of speech recognition to the speech recognition broadcasting apparatus 203.

The speech recognition broadcasting apparatus 203 receives the at least one of EPG search information and control information of the speech recognition broadcasting apparatus, and at step 255, performs a search or control according to the EPG search information or control information of the speech recognition broadcasting apparatus 203 received. That is, in a case of receiving the EPG search information, the speech recognition broadcasting apparatus 203 performs a search according to the corresponding search information and outputs a search screen, and in a case of receiving control information, the speech recognition broadcasting apparatus 203 performs a control of the speech recognition broadcasting apparatus 203 according to the corresponding control information.

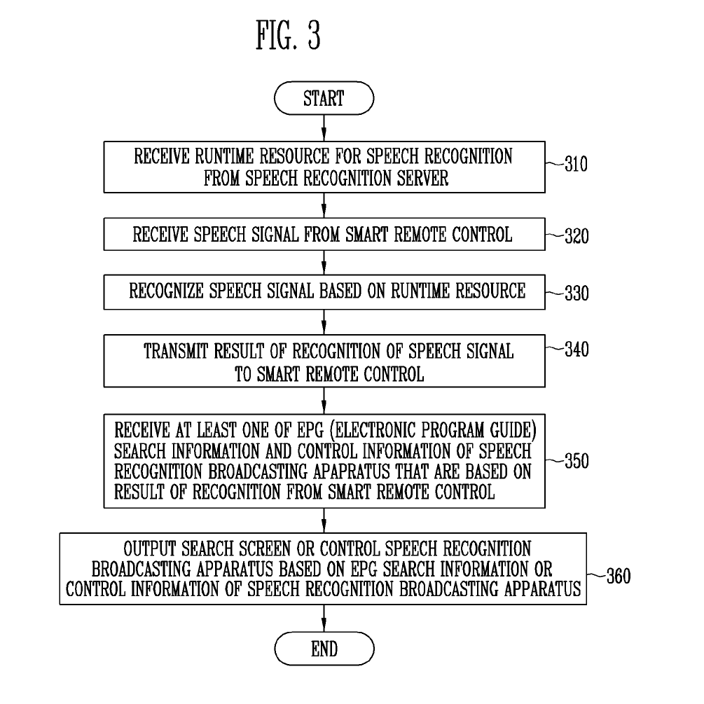

FIG. 3 is a flowchart illustrating a method for controlling a speech recognition broadcasting apparatus that uses a smart remote control according to an embodiment of the present invention.

First of all, at step 310, a speech recognition broadcasting apparatus 203 receives a runtime resource for speech recognition from a speech recognition server 202. The speech recognition broadcasting apparatus 203 receives the runtime resource for speech recognition from the speech recognition server 202 to directly analyze and process a speech signal. Herein, the received runtime resource for speech recognition may be one created based on EPG information that the speech recognition server 202 received from a media server 201.

Then, at step 320, when the speech recognition broadcasting apparatus 203 receives a speech signal from a smart remote control 204, the speech recognition broadcasting apparatus 203 may proceed to step 330 and recognize the received speech signal based on the received runtime resource for speech recognition, and at step 340, the speech recognition broadcasting apparatus 203 may transmit a result of recognition of the speech signal to the smart remote control. Herein, the speech signal may be one converted from a user's speech input. Such communication between the speech recognition broadcasting apparatus 203 and the smart remote control 204 may be performed through infrared transmission. Furthermore, in a case where the speech recognition broadcasting apparatus 203 and the smart remote control 204 are both connected to a network, the communication may be performed using wireless communication such as WiFi, 3G, and 4G or using wired communication.

Moreover, at step 350, the speech recognition broadcasting apparatus 203 may receive at least one of the EPG search information and control information of the speech recognition broadcasting apparatus that are based on the result of speech recognition, and proceed to step 360 and output a search screen or control the speech recognition broadcasting apparatus based on the EPG search information or control information of the speech recognition broadcasting apparatus. Herein, in a case of receiving the EPG search information, the speech recognition broadcasting apparatus 203 may perform a search according to the corresponding search information and output a search screen, and in a case of receiving the control information, the speech recognition broadcasting apparatus 203 may perform a control of the speech recognition broadcasting apparatus 203 according to the corresponding control information.

EPG search information according to an embodiment of the present invention is as follows.
Program title search: (search ‘Moon that embraces Sun’, or KBS news etc.)
Name search: cast/director/MC: (Dong Geon Chang, Joon Ho Bong, Hwi Jae Lee etc.)
Internet search function: (search ‘Running Man’ in Naver etc.)
It is possible to analyze EPG information on a channel and program title, attach a tag beforehand so as to quickly apply a user's intention upon recognition.
   Turn to MBC_CHANNEL_{—}11
   Search ‘One night_two days_{———}TITLE’

Furthermore, control information according to an embodiment of the present invention is as follows.
Channel: name of broadcasting station and channel number (turn to MBC, turn to channel no. 11 etc.)
Interpret a character string input through speech and generate a control signal
Volume: (pump up the volume, pump up the volume by 3 notches, mute etc.)
Recording and replaying functions: (record this, record list etc.)
Screen: control size and brightness (16:9, brighter screen etc.)
Smart TV application: (execute KaKaotalk etc.)
Help function: (TV guide, channel information etc.)

Such EPG search information or control information of a speech recognition broadcasting apparatus may be embodied by inputting characters through speech recognition and OSD controlling. Inputting characters may proceed by interpreting a character string (mixture of Korean characters, numbers, and English characters) in syllable units, and then searching keyboard arrangement information of a virtual keyboard appearing on the speech recognition broadcasting apparatus and inputting characters through a simulation based on relative location information between keys. Furthermore, OSD controlling may configure speech recognition to move and select based on the relative location information between menus displayed on the screen, and perform commands such as “two columns downwards”, “four columns upwards”, and “confirm” etc.

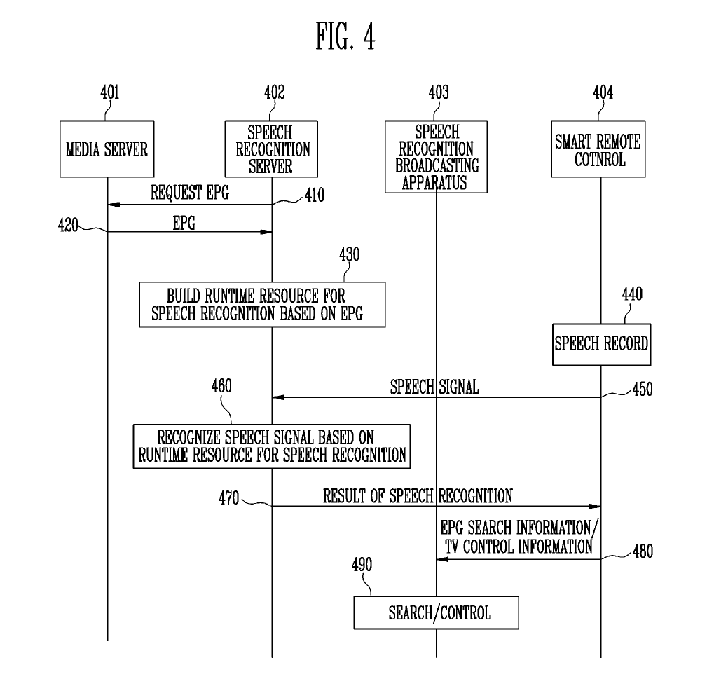

FIG. 4 is a flowchart illustrating a method for operating a speech recognition broadcasting system that uses a smart remote control according to another embodiment of the present invention.

Referring to FIG. 4, first of all, at step 410, a speech recognition server 402 requests EPG information to a media server 401, in which case the media server 401 receives the request, and at step 420, the media server 401 transmits the EPG information to the speech recognition server 402.

Then, at step 430, the speech recognition server 420 creates a runtime resource for speech recognition based on the received EPG information. Herein, at step 420, the speech recognition server 402 may create the runtime resource for speech recognition based on the EPG information received from the media server 401.

At step 440, a smart remote control 404 receives a user's speech and converts it into a speech signal, and at step 450, the smart remote control 404 transmits the speech signal to the speech recognition server 402. The speech recognition server 402 that received the speech signal proceeds to step 460, and recognizes the speech signal based on the runtime resource for speech recognition created at step 430. Then, the speech recognition server 402 transmits a result of speech recognition to the smart remote control 404. Unlike the embodiment of FIG. 2 where a process of speech recognition is performed at the speech recognition broadcasting apparatus 403, the embodiment illustrated in FIG. 4 performs a process of speech recognition in the speech recognition server 402. Therefore, communication is performed between the speech recognition server 402 and the smart remote control 404, and such communication may be performed using wireless communication such as WiFi, 3G, and 4G or using wired communication.

Moreover, the smart remote control 404 receives the result of speech recognition, and at step 480, the smart remote control 404 transmits at least one of EPG search information and control information of the speech recognition broadcasting apparatus that are based on the result of speech recognition to the speech recognition broadcasting apparatus 403.

The speech recognition broadcasting apparatus 403 receives the result of speech recognition, and at step 490, the speech recognition broadcasting apparatus 403 performs a search or control according to the received EPG search information or control information of the speech recognition broadcasting apparatus 403. That is, in a case of receiving the EPG search information, the speech recognition broadcasting apparatus 403 performs a search according to the corresponding search information and outputs a search screen, and in a case of receiving the control information, the speech recognition broadcasting apparatus 403 performs a control of the speech recognition broadcasting apparatus 403 according to the control information.

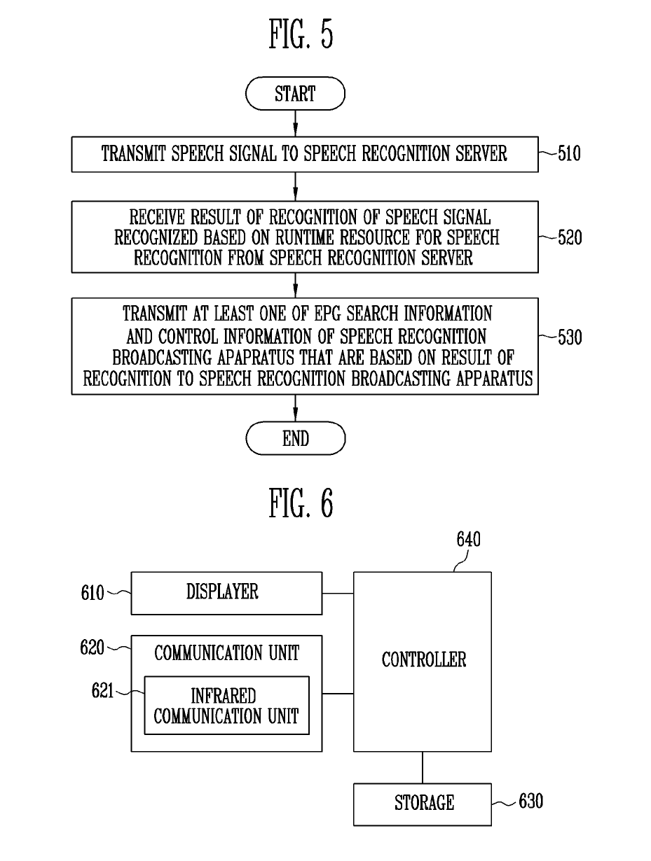

FIG. 5 is a flowchart illustrating a method for controlling a speech recognition broadcasting apparatus that uses a smart remote control according to another embodiment of the present invention.

First of all, at step 510, a smart remote control 404 transmits a speech signal to a speech recognition server 402. Herein, the speech signal may be one converted from a user's speech input.

Then, the smart remote control 404 receives a result of recognition of the speech signal recognized based on a runtime resource for speech recognition from the speech recognition server 402. Herein, the runtime resource for speech recognition may be one created based on EPG information that the speech recognition server 402 received from a media server 401. Communication is made between the speech recognition server 402 and the smart remote control 404, and such communication may be performed using wireless communication such as WiFi, 3G, and 4G or using wired communication.

A result of recognition of a speech signal may be provided by attaching a tag that reflects serial information of a corresponding word to a speech recognition character string. Based on this result of recognition of a speech signal, it is possible to quickly and efficiently search broadcasting information after the speech recognition.

Such a tag may be provided by registering a sentence type that frequently occurs for EPG information search and tagging the same. A tag according to an embodiment of the present invention is as follows.

Search {find_q} the drama {genre} where Dong Geon Chang {actor} appears {appearance }.

Furthermore, a tag may be provided such that new broadcasting information is automatically applied to a sentence frame pre-established based on a class n-gram, so as to provide a function of searching a natural word. A tag according to an embodiment of the present invention is as follows.

Dong Geon Chang→{actor}

Moon that embraces Sun→{program_title}

Movie→{genre }

Furthermore, the smart remote control 404 may transmit at least one of EPG search information or control information of the speech recognition broadcasting apparatus 403 that are based on a result of speech recognition to the speech recognition broadcasting apparatus 403, and may output a search screen or control the speech recognition broadcasting apparatus 403. Such communication between the speech recognition broadcasting apparatus 403 and the smart remote control 404 may be performed through infrared transmission. Furthermore, in a case where the speech recognition broadcasting apparatus 403 and the smart remote control 404 are both connected to a network, communication may be performed using wireless communication such as WiFi, 3G and 4G, or using wired communication.

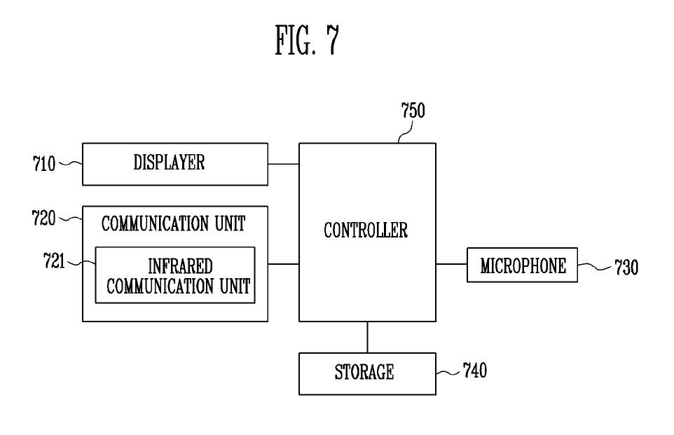

FIG. 6 is a view illustrating an inner structure of a speech recognition broadcasting apparatus according to another embodiment of the present invention.

A speech recognition broadcasting apparatus may include a displayer 610, communication unit 620, storage 630, and controller 640.

The displayer 610 plays a role of displaying contents. The displayer 610 plays a role of displaying (outputting) information being processed in a terminal apparatus 200. The displayer 610 may include at least one of an LCD (Liquid Crystal Display), TFT LCD (Thin Film Transistor-LCD), LED (Light Emitting Diode), OLED (Organic LED), active LED (Active Matrix OLED), flexible display, bended display, and 3-dimensional display. Some of these displays may be embodied in a transparent display that is configured as a transparent or phototransparent type so that its external part can be seen. A displayer 610 according to an embodiment of the present invention may output a search screen according to the EPG search information or output a control screen.

The communication unit 620 plays a role of transmitting/receiving data to/from an external apparatus. The communication unit 620 may include a wired communication unit and wireless communication unit. Therefore, the communication unit 620 may include one or more modules that enable communication between the speech recognition broadcasting apparatus and a wired/wireless communication system or in a network where the speech recognition broadcasting apparatus is included. For example, the communication unit 620 may include a LAN (Wireless Local Area Network) module and a mobile communication module and so forth. Furthermore, a communication unit 620 according to an embodiment of the present invention may include an infrared communication unit 621.

The storage 630 may store a program for processing and controlling the controller 640, and may perform a function of storing data being input/output. The storage 630 may include a memory such as a flash memory type memory, hard disk type memory, micro type memory, and card type memory (for example, SD card or XD card) and so forth, and at least one of type storage medium of a RAM (Random Access Memory), SRAM (Static RAM), ROM (Read-Only Memory), PROM (Programmable ROM), EEPROM (Electrically Erasable PROM), MRAM (Magnetic RAM), magnetic disk, and optical disk and so forth.

A storage 630 according to an embodiment of the present invention may store a received runtime resource for speech recognition.

The controller 640 plays a role of controlling overall operations of a speech recognition broadcasting apparatus.

A controller 640 according to an embodiment of the present invention may receive a runtime resource for speech recognition from a speech recognition server through a communication unit 620, receive a speech signal from a smart remote control, and control a process of recognizing a speech signal based on the received runtime resource for speech recognition. Furthermore, the controller 640 may transmit a result of recognition of a speech signal to the smart remote control through the communication unit 620, receive at least one of EPG search information or control information of the speech recognition broadcasting apparatus that are based on a result of recognition from the smart remote control, and output a search screen or control the speech recognition broadcasting apparatus based on the EPG search information or control information of the speech recognition broadcasting apparatus.

FIG. 7 is a view illustrating an inner structure of a smart remote control apparatus according to another embodiment of the present invention.

A speech recognition broadcasting apparatus may include a displayer 710, communication unit 720, microphone 730, storage 740, and controller 750.

The displayer 710 plays a role of displaying contents. The displayer 610 plays a role of displaying (outputting) information being processed in a terminal apparatus 200. The displayer 610 may include at least one of an LCD (Liquid Crystal Display), TFT LCD (Thin Film Transistor-LCD), LED (Light Emitting Diode), OLED (Organic LED), active OLED (Active Matrix OLED), flexible display, bended display, and 3-dimensional display. Some of these displays may be embodied in a transparent display that is configured as a transparent or phototransparent type so that its external part can be seen. A displayer 710 according to an embodiment of the present invention may display a result of speech recognition, and output a control screen of a speech recognition broadcasting apparatus.

The communication unit 720 plays a role of transmitting/receiving data to and from an external apparatus. The communication unit 720 may include a wired communication unit and a wireless communication unit. Therefore, the communication unit 720 may include one or more modules that enable communication between the speech recognition broadcasting apparatus and a wired/wireless communication system or in a network where the speech recognition broadcasting apparatus is included. For example, the communication unit 720 may include a LAN (Wireless Local Area Network) module, and a mobile communication module and so forth. Furthermore, a communication unit 720 according to an embodiment of the present invention may include an infrared communication unit 721.

The microphone 730 plays a role of inputting sound into a smart remote control. A microphone 730 according to an embodiment of the present invention may receive a user's speech and convert it into a speech signal.

The storage 740 may store a program for processing and controlling the controller 750, or perform a function of storing data being input/output. The storage 740 may include a memory such as a flash memory type memory, hard disk type memory, micro type memory, and card type memory (for example, SD card or XD card) and so forth, and a storage medium of at least one of type of memory such as a RAM (Random Access Memory), SRAM (Static RAM), ROM (Read-Only Memory), PROM (Programmable ROM), EEPROM (Electrically Erasable PROM), MRAM (Magnetic RAM), magnetic disk, and optical disk and so forth.

A storage 740 according to an embodiment of the present invention may store a speech signal.

The controller 750 plays a role of controlling overall operations of a speech recognition broadcasting apparatus.

A controller 750 according to an embodiment of the present invention may transmit a speech signal to a recognition server through a communication unit 720, and control a process of receiving a result of recognition of the speech signal recognized based on a runtime resource for speech recognition from the speech recognition server. Furthermore, the controller 750 may control such that at least one of EPG search information or control information of a speech recognition broadcasting apparatus that are based on a result of speech recognition is transmitted to the speech recognition broadcasting apparatus.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A method for controlling a speech recognition broadcasting apparatus using a smart remote control, the method comprising:
receiving a runtime resource for speech recognition from a speech recognition server;
receiving a speech signal from the smart remote control;
recognizing the speech signal based on the received runtime resource for speech recognition;
transmitting a result of recognition of the speech signal to the smart remote control;
receiving at least one of EPG (Electronic Program Guide) search information or control information of the speech recognition broadcasting apparatus which are based on the result of recognition from the smart remote control; and
outputting a search screen based on the EPG search information or controlling the speech recognition broadcasting apparatus based on control information of the speech recognition broadcasting apparatus.

2. The method according to claim 1,
wherein the runtime resource for speech recognition is a runtime resource for speech recognition created based on EPG information at the speech recognition server.

3. The method according to claim 2,
wherein the speech recognition server requests the EPG information to a media server that stores the EPG information, receives the EPG information accordingly, and creates the runtime resource for speech recognition.

4. The method according to claim 1,
wherein the speech signal is one converted from a user's speech input at the smart remote control.

5. A method for controlling a speech recognition broadcasting apparatus using a smart remote control, the method comprising:
transmitting a speech signal to a speech recognition server;
receiving a result of recognition of the speech signal recognized based on a runtime resource for speech recognition from the speech recognition server; and
transmitting at least one of EPG search information and control information of the speech recognition broadcasting apparatus which are based on the result of recognition to the speech recognition broadcasting apparatus.

6. The method according to claim 5,
wherein the runtime resource for speech recognition is a runtime resource for speech recognition created based on EPG information at the speech recognition server.

7. The method according to claim 6,
wherein the speech recognition server requests the EPG information to a media server that stores the EPG information, receives EPG information accordingly, and creates the runtime resource for speech recognition.

8. The method according to claim 5,
further comprising receiving a user's speech and converting it into the speech signal.

9. A speech recognition broadcasting apparatus using a smart remote control, the apparatus comprising:
a communication unit communicating with an external apparatus; and
a controller receiving a runtime resource for speech recognition from a speech recognition server through the communication unit, receives a speech signal from the smart remote control, recognizes the speech signal based on the received runtime resource for speech recognition, transmits a result of recognition of the speech signal to the smart remote control through the communication unit, receives at least one of EPG search information and control information of the speech recognition broadcasting apparatus which are based on the result of recognition from the smart remote control, and outputs a search screen based on the EPG search information or controls the speech recognition broadcasting apparatus based on control information of the speech recognition broadcasting apparatus.

10. The apparatus according to claim 9,
wherein the runtime resource for speech recognition is a runtime resource for speech recognition created based on EPG information at the speech recognition server.

11. The apparatus according to claim 10,
wherein the speech recognition server requests the EPG information to a media server that stores the EPG information, receives the EPG information accordingly, and creates the runtime resource for speech recognition.

12. The apparatus according to claim 9,
wherein the speech signal is a user's speech received from the smart remote control and stored.
